(19) United States
(12) Patent Application Publication
(10) Pub. No.: US 2008/0243304 A1
(43) Pub. Date: Oct. 2, 2008

(54) ROBOT

(75) Inventor: Takashi Yoshimi, Fujisawa-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/052,005

(22) Filed: Mar. 20, 2008

(30) Foreign Application Priority Data
Mar. 27, 2007 (JP) P2007-081588

(51) Int. Cl. G06F 19/00

(52) U.S. Cl. 700/245; 901/2

(57) ABSTRACT

According to an aspect of the invention, there is provided According to an aspect of the invention, there is provided a robot including: a body; a arm attached to the body; a container storing compressed air; at least one air emission port formed in at least one of a surface of the body and a surface of the arm; a pipe network connecting the container to the air emission port; and a control section configured to control the body, the arm, and emission of an air based on an operation of at least one of the body and the arm.

### CROSS-REFERENCE TO RELATED APPLICATIONS

This application is based on and claims the benefit of priority from the prior Japanese Patent Application No. 2007-081588, filed on Mar. 27, 2007; the entire contents of which are incorporated herein by reference.

### TECHNICAL FIELD

The present invention relates to a robot which coexists with a human and which operates in the neighborhood of a person, and more particularly to a robot which takes into consideration of the safety of persons located around the robot.

### BACKGROUND

In order to ensure the safety of persons around a robot, a safety fence is put around the robot, to thus hinder the persons from approaching the robot in service. It is disclosed by, for example, “Technical Guidelines on Safety Standards for Use of an Industrial Robot, and the like” Online Safety Information from Safety and Sanitation Information Center of Central Industrial Accident Prevention Association (http://ww.jaish.gr.jp/anzen/hor/hombun/hor1-7/hor1-7-13-1-0.htm) that an interlock system, such as a warning lamp, is provided around the fence so that the persons located around the robot can readily ascertain a state where a servo power of the robot is energized or where anomalies exist in the robot and in which the servo power of the robot is shut off when an entrance door of the safety fence is opened.

In the meantime, the robot coexistent with a human has been developed for the purpose of moving around a person or providing the person with various services by actuating robot arms beside the person and cannot used while being isolated within the fence as in the case of an industrial robot. Accordingly, in order to safely actuate the robot around the person, the robot should operate safely. However, in addition, it is necessary to inform those around the robot of activation of a main power or the servo power of the robot by any means, to thus issue a warning. One way is to inform the persons located around the robot of activation of the servo power with a lamp attached to a main body. A hobby robot which illuminates a lamp attached to a main body, to thus show the time of activation of power or an operating status of a servo has been on sale (see; for example, Product Catalogue of Robot Arm MR-999 manufactured by EK Japan Co., Ltd. http://www.elekit.co.jp/material/japanese_product html/MR-999.php). However, under the method, start-up and a destination of a robot or a range of motion cannot be furnished to those around the robot.

For these reasons, there has already been proposed a method for displaying, on a robot main body or a floor around the robot, how the robot will move from now, to thus provide the persons located around the robot with movement which will be performed from now (see; for example, Matsumal et al.: “Study on Remote Control of Robot Coexistent with a Human (34^{th} Report)—Development and Evaluation of Movable Robot with a Movement Notification Function using a Projector—,” Robotics and Mechatronics Lecture 2006 (Robocome 2006), the Japan Society of Mechanical Engineers, 2PI-A37 and Matsumal et al.: “Study on Remote Control of Robot Coexistent with a Human (31^{st} Report)—Development and Evaluation of Movable Robot with a Movement Notification Function using an Omnidirectional Display—,” Robotics and Mechatronics Lecture 2006 (Robocome 2006), the Japan Society of Mechanical Engineers, 2PI-A31). According to the method, the persons located around the robot can ascertain the way of the robot starting movement, so that safety can be ensured.

Moreover, a device utilizing emission of an air has also been proposed as a device which causes the persons located in the neighborhood to ascertain approach of an object (see; for example, JP-A-2001-171983). An upper rotary element of a power shovel is provided with a proximity sensor and an air emission nozzle, and an air is emitted from an air emission nozzle in response to proximity detection operation of the proximity sensor, thereby informing an operator of an approach of the upper rotary element.

However, due to a technique for showing the presence of the robot and start-up of the robot and an operation range of the robot, to thus draw attention of persons located around the robot or urge the persons to avoid collision, persons round the robot should watch a lamp of the robot or a display of a projector carefully at all times. A person often fails to realize motion of a robot while not looking at the robot.

In the case of the example heavy machinery for construction purpose, an air is not emitted unless the operator approaches the rotary element as far as the range where the operator is detected by the proximity sensor. Consequently, the operator cannot predict movements of the heavy machinery which will be performed; for example, a direction of movement, a range of movement, a travel speed, and the like. Thus, the technique is not insufficient in terms of attraction of attention from the person and avoidance of collision.

### SUMMARY

According to an aspect of the invention, there is provided a robot including: a body; a arm attached to the body; a container storing compressed air; at least one air emission port formed in at least one of a surface of the body and a surface of the arm; a pipe network connecting the container to the air emission port; and a control section configured to control the body, the arm, and emission of an air based on an operation of at least one of the body and the arm.

### BRIEF DESCRIPTION OF THE DRAWINGS

In the accompanying drawing:

FIG. 1 is a block diagram showing an embodiment of a robot of the present invention;

FIG. 2 is an external conceptual rendering showing an embodiment of the robot;

FIG. 3 is a schematic descriptive view of an arm used in the robot;

FIG. 4 is a schematic connection diagram showing a connection between an air emission unit and an air emission control section used in the robot;

FIG. 5 is a flowchart showing basic steps of an algorithm pertaining to operation performed by the air emission control section used in the robot;

FIG. 6 is a schematic descriptive view of setting of “direction of air emission” of an arm used in the robot;

FIG. 7 is a flowchart of detailed internal steps of a basic step of the algorithm pertaining to operation performed by the air emission control section used in the robot;

FIG. 8 is a flowchart of detailed internal steps of a basic step of the algorithm pertaining to operation performed by the air emission control section used in the robot;

FIG. 9 is a flowchart of detailed internal steps of a basic step of the algorithm pertaining to operation performed by the air emission control section used in the robot;

FIG. 10 is a flowchart of detailed internal steps of a basic step of the algorithm pertaining to operation performed by the air emission control section used in the robot;

FIG. 11 is a flowchart of detailed internal steps of a basic step of the algorithm pertaining to operation performed by the air emission control section used in the robot;

FIG. 12 is a flowchart of detailed internal steps of a basic step of the algorithm pertaining to operation performed by the air emission control section used in the robot;

FIG. 13 is a flowchart of detailed internal steps of a basic step of the algorithm pertaining to operation performed by the air emission control section used in the robot; and

FIG. 14 is an external view showing an exemplification of a modification of the robot.

### DESCRIPTION OF THE EMBODIMENTS

Embodiments of the present invention will be described hereunder by reference to the drawings.

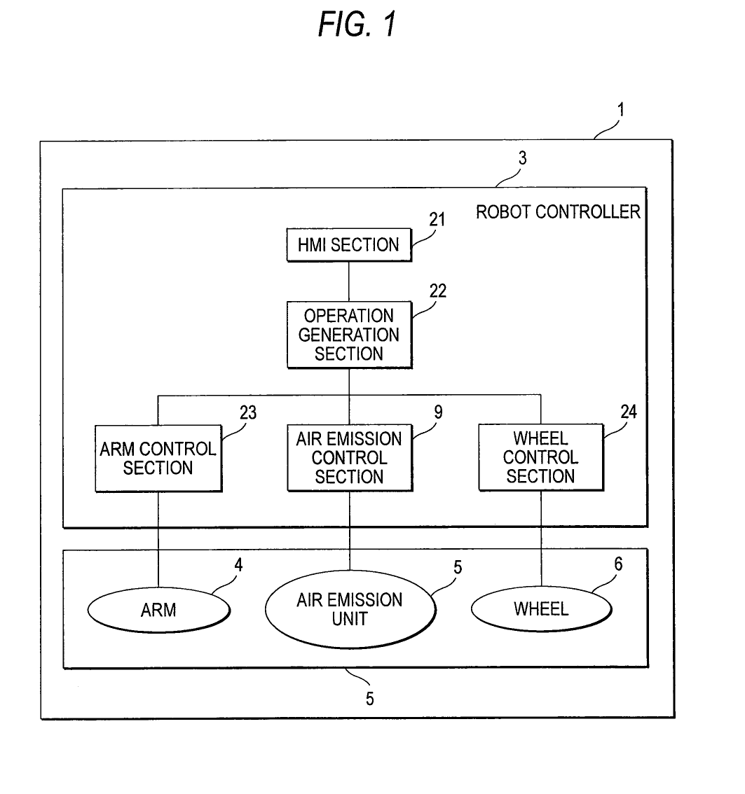

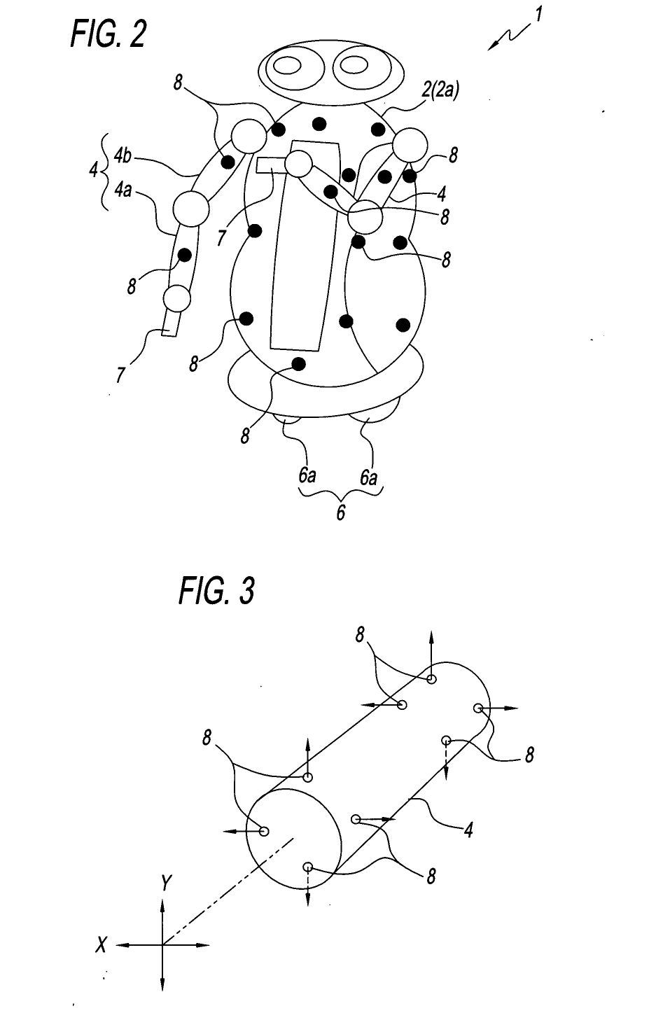

FIG. 1 is a block diagram showing an embodiment of a robot provided with human-safe measures, and FIG. 2 is a conceptual rendering of the appearance of the robot.

As shown in FIG. 1, a robot 1 is roughly configured by a robot structural body 2 which is a structure, and a robot controller 3 which is attached to the robot structural body 2 and which controls individual sections of the robot structural body 2.

In the robot structural body 2, individual portions are attached to the robot main body 2a having a body and a head. The attached individual portions include robot arms 4 (hereinafter simply called “arms”) which can be actuated freely in response to a command from the robot controller 3; an air emission unit 5 capable of emitting an air from the individual portions of the robot main body 2a and the arms 4 in accordance with various modes; and wheels 6 for moving the robot structural body 2 in a predetermined direction.

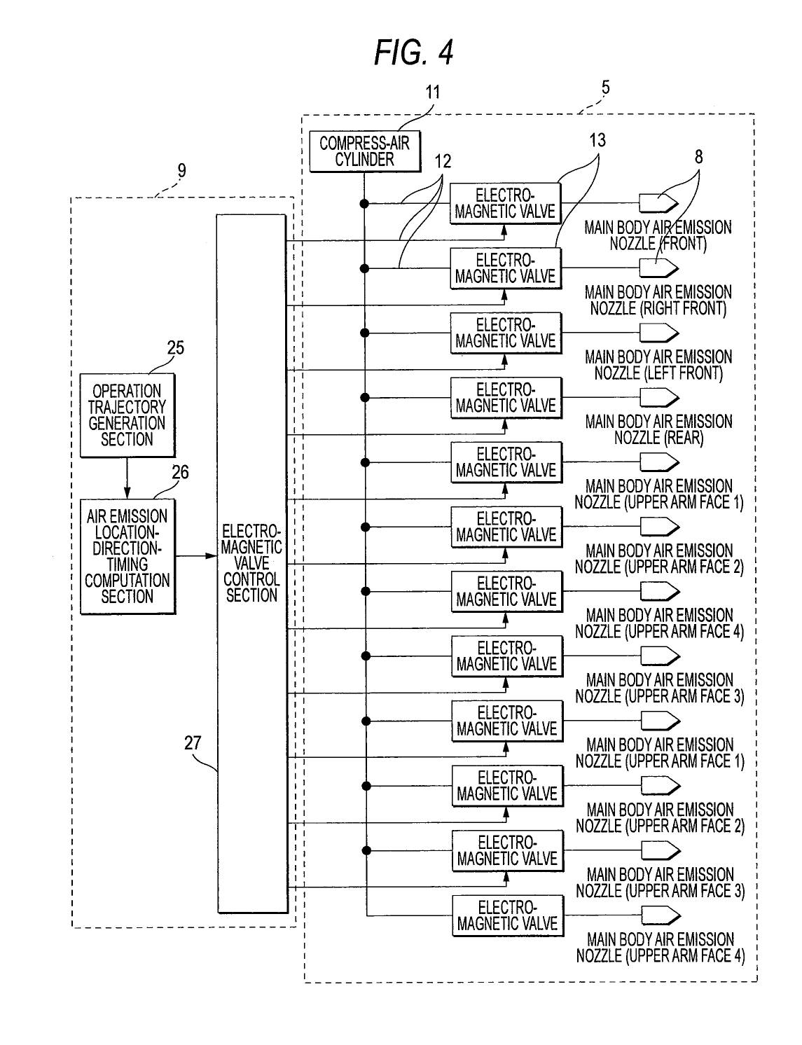

The arms 4 are of a well-known structure using a motor built in each rotary joint. In each arthrosis, an upper arm 4a and a forearm 4b operate freely, and a grip portion (hand) 7 is formed at an extremity of the forearm 4b. Further, as a schematic explanatory view of the arm 4 is shown in FIG. 3, a plurality of air emission nozzles (air emission ports) 8 are formed in the surface of the arm 4 along both X and Y directions. Arrows shown in FIG. 3 designate directions where an air is emitted.

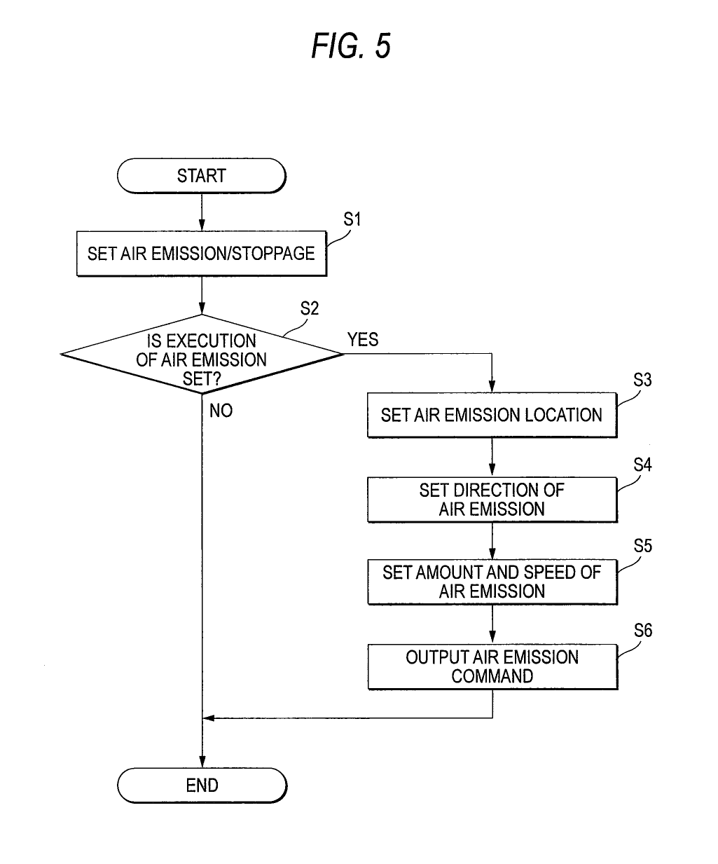

The air emission unit 5 will be described with reference to FIG. 4 pertaining to a connection between the air emission unit 5 and an air emission control portion 9 (which will be described in detail later). Specifically, the air emission unit 5 is configured by a compressed-air cylinder 11 serving as a container and the air emission nozzles 8 serving as a plurality of air emission ports which are connected, by electromagnetic valves 13, to pipes 12 of a pipe network formed from the compressed-air cylinder 11 and the plurality of pipes 12 and which are provided in the arms 4 and the robot structural body 2. The air emission nozzles 8 provided in the robot structural body 2 are provided in; for instance, a front face, a right forward, a left forward, and a back of the main body. The air emission nozzles 8 provided in the arms 4 are provided in the upper arm 4a and the forearm 4b for each arthrosis of the arm 4.

The compressed-air cylinder 11 is configured so as to be removably attached to the main body. When compressed air in the compressed-air cylinder 11 has become nearly depleted, the cylinder is replaced.

The wheels 6 are driven by a motor (not shown). In addition to two drive wheels 6a, the wheels 6 have driven casters configured so as to be able to change their directions with respect to a direction of movement set along the longitudinal direction of the drive wheels 6a.

The robot controller 3 is provided with an interface section 21 (an HMI section) serving as an interface between a user and a robot by user's operation performed by a remote control panel, and the like; an operation generation section 22 which generates operations of the respective portions, that is, operation of the arms 4, operation of the air emission unit 5, and operation of the wheels 6 in response to a command from the interface section 21; an arm control section 23 for performing operations of the respective portions generated by the operation generation section 22, that is, operations of the arms 4; an air emission control section 9 for controlling an air emitted from the air emission nozzles 8 in accordance with various modes of motion of the robot structure body 2; and a wheel control section 24 which drives the wheels 6 at a predetermined speed in a predetermined reaction in order to move the robot 1.

As indicated by a connection of the air emission unit 5 in FIG. 4, the air emission control section 9 has an air emission location-direction-timing computation section 26 which performs arithmetic operation upon receipt of an input signal from an operation trajectory generation section 25 provided in the operation generation section 22; and an electromagnetic valve control section 27 for controlling the electromagnetic valve 13 in accordance with a result output by the computation section 26.

By thus configuration, the air emission control section 9 controls the air emission unit 5 in accordance with a command issued by the operation generation section 22 for operating the arms 4 or the wheels 6, in order to show the presence, timing of movement, and operation range of the robot 1 to a person, thereby regulating the intensity and amount of an air emitted from the air emission nozzles 8 provided in the robot structural body 2 and the surface of the arms 4.

The robot coexistent with a human is based on the premise that the robot moves around a person, and hence operation of the robot involving dragging of electric wiring or a pipe is not desirable. Therefore, in the present embodiment, an air is emitted from the air emission nozzles 8 by use of the compressed-air cylinder 11 removably stored in the robot main body 2a.

Output-side signal lines of the respective control sections 9, 23, and 24 are connected to input sides of respective objects of control.

A processing algorithm performed by the air emission control section 9 that controls the air emitted from the air emission nozzles 8 in accordance with various modes of motions of the robot 1 will now be described.

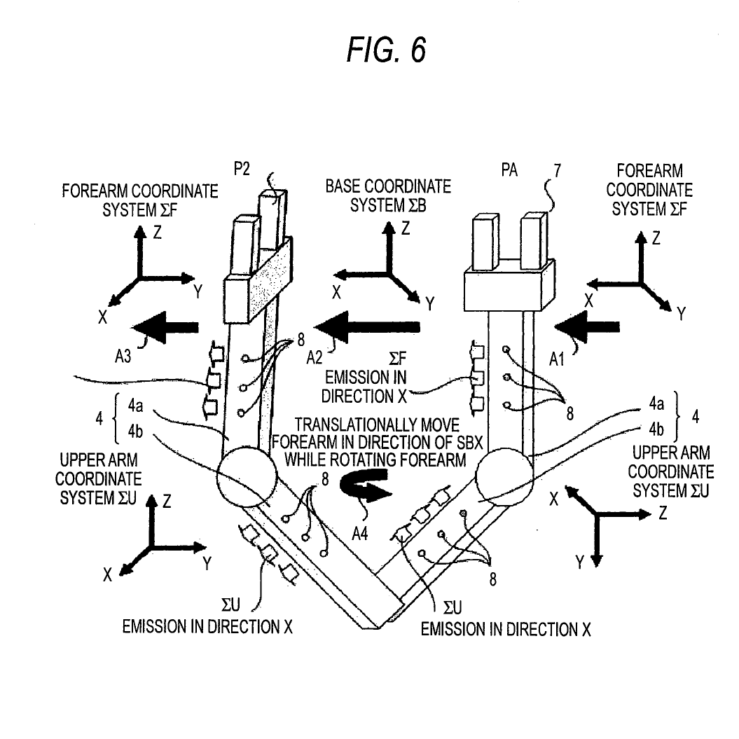

FIG. 5 is a flowchart showing basic steps of the algorithm pertaining to the operation of the air emission control section 9. Further detailed internal steps of each of the basic steps will be described later. In the following descriptions, the individual sections are referred to by the designations and reference numerals shown in FIGS. 1 through 4.

In the basic step, the operation generation section 22 first sets an “air emission or stoppage of air emission” (step S1).

A determination is made, at set timing, as to whether or not execution of air emission is set (step S2).

When air emission is determined to be executed, an “air emission location” is set on the nozzles 8 of the robot main body 2a and the arms 4 of the robot structural body 2 (step S3).

Next, a “direction of air emission,” such as a longitudinal direction, is set in connection with the nozzles 8 of the robot main body 2a or the arms 4 set in the “air emission location.” (step S4).

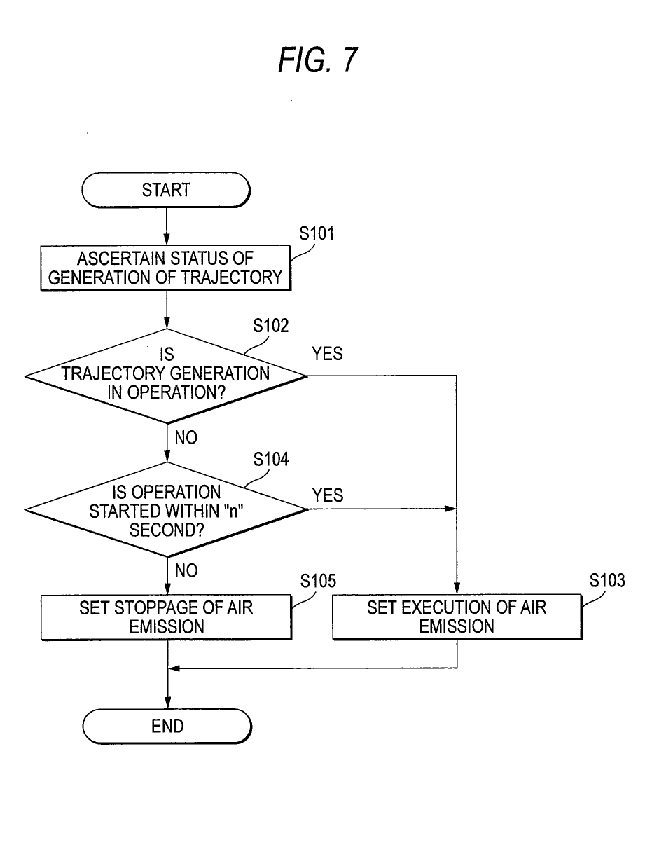

FIG. 6 is a diagrammatic explanatory view of setting of the “direction of air emission.” Specifically, when the arms 4 are actuated along a direction of an arrow A1→a direction of an arrow A2 (the forearm 4a is moved in a direction X in a base coordinate system while being rotated in a direction of arrow A4)→a direction of an arrow A3, the forearm 4a provided with the grip section 7 emits, at position P1, an air from the nozzles arranged in the direction X within the coordinate system of the forearm. At position P2, the forearm 4a emits an air from the nozzles 8 arranged in a direction −Y of the coordinate system of the forearm.

At position P1, the upper arm 4b emits an air from the nozzles arranged in the direction X in the coordinate system of the upper arm. At position P2, an air is emitted from the nozzles 8 arranged in the direction X even in the coordinate system of the upper arm.

It is possible to turn attention of the person to the direction of actuation of the arms 4 at all times, by settings of the nozzles 8.

The amount and speed of air emissions of the nozzle 8 are set for which the “direction of air emission” has been set (step S5).

The “amount and speed of air emissions” are selected from data stored in a database (not shown).

In response to an output of “air emission command” (step S6), an air is emitted from the nozzles 8 according to the set conditions.

When the operation generation section 22 has determined an “air emission stoppage” and timing thereof, emission of an air from the nozzles 8 is stopped, and processing is terminated.

Next, more detailed internal steps of the respective basic steps shown in FIG. 5 will be described in sequence.

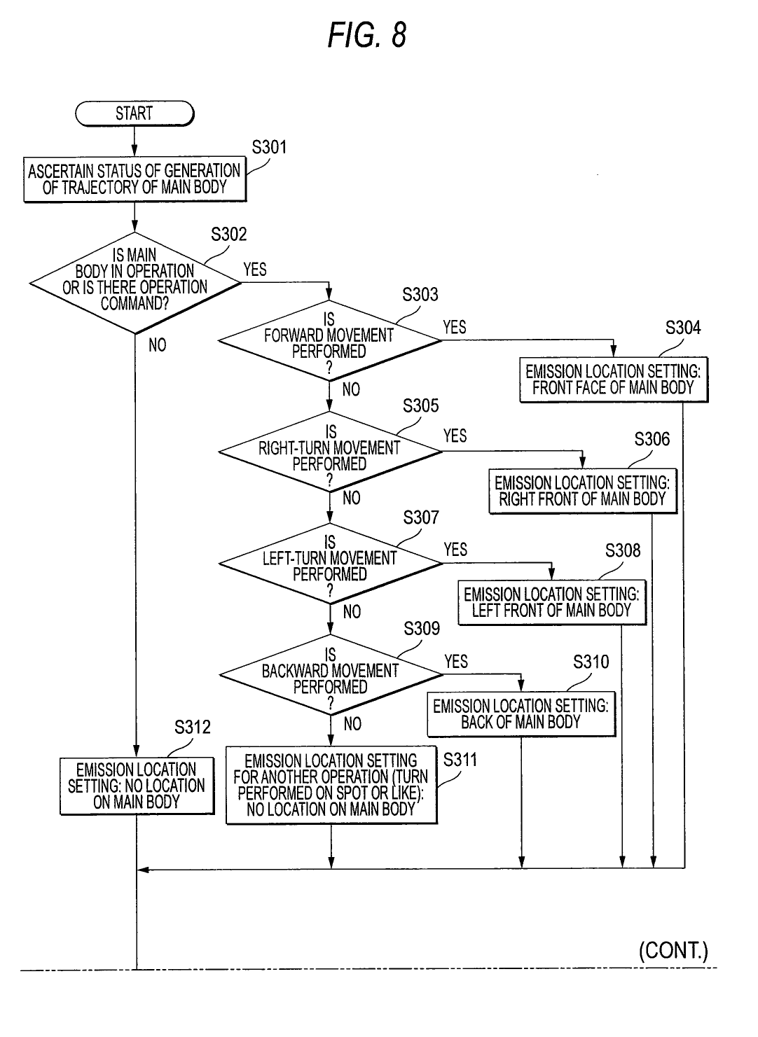

First, internal detailed steps of the “air emission or stoppage of air emission” (step S1) of the basic steps will be described. FIG. 7 is a flowchart of detailed internal steps of “air emission or stoppage of air emission” (step S1).

“Trajectory generation status” which is information necessary for moving the robot 1 is first ascertained (step S101).

A determination is made as to whether or not the “trajectory generation status” is in operation (step S102).

When a result of determination is “in operation,” “execution of air emission” from the nozzles 8 is set (step S103).

In the meantime, when the result of determination shows that the trajectory generation status is not in operation, another determination is made as to whether or not “operation is initiated within “n” seconds” (step S104).

When a result of the determination made as to whether or not “operation is initiated within “n” seconds” is YES, “execution of air emission” is set. In contrast, when the determination result shows NO, “stoppage of air emission” is set (step S105).

After “execution of air emission” has been set in step S103 or after “stoppage of air emission” has been set in step S105, processing is terminated.

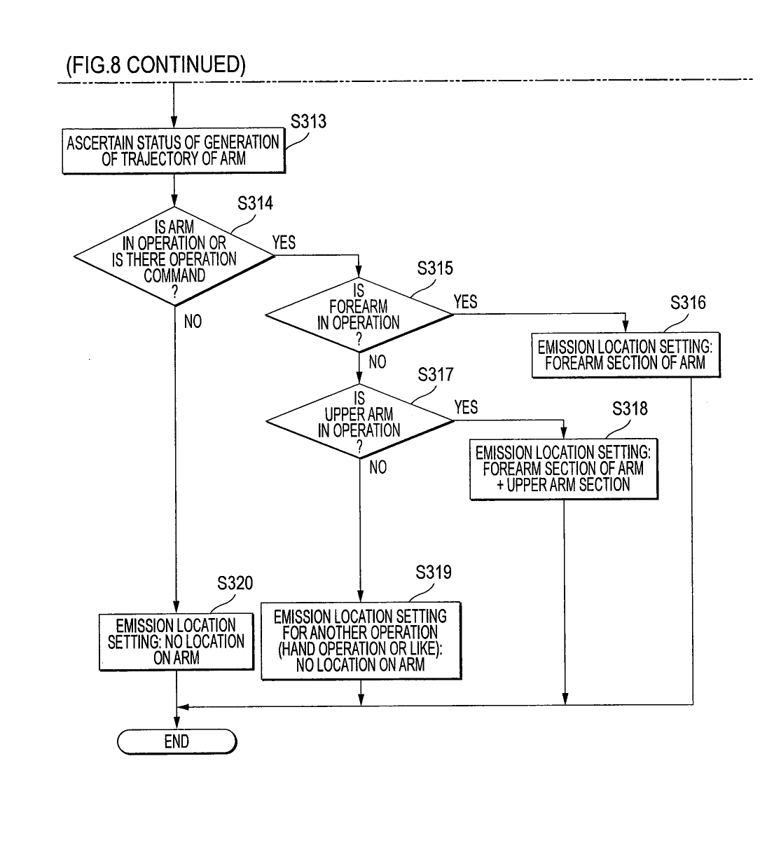

Next, detailed inner steps of the “air emission point setting” (step S3) of the basic steps shown in FIG. 5 will be described. FIG. 8 is a flowchart of detailed inner steps of the “air emission point setting” (step S3).

“Trajectory generation status” which is information necessary for the operation generation section 22 to move the robot 1 is first ascertained (step S301).

A determination is made, through ascertainment, as to whether or not the trajectory status is in operation or whether or not the trajectory status requires an operation command (step S302).

When a result of determination rendered in S302 is YES, a determination is sequentially made as to whether individual operation is in operation or requires a command, in connection with “forward movement,” “right-turn movement,” “left-turn movement,” and “backward movement.” When YES is determined, an emission location is set on the respective nozzles 8 of the main body in accordance with the thus-determined motion (step S303 to step S310).

When all of the determinations—as to whether “forward movement,” “right-turn movement,” “left-turn movement,” and “backward movement” are in operation or require a command—are rendered as NO, “emission location setting for another operation (rotation performed on the spot or the like): no location on the main body” is set (step S311).

Subsequently to step S311, “arm 4 trajectory generation status” which is operation of the arm control section 23 is ascertained in connection with the arms 4 (step S313).

In the meantime, when a result of the determination as to whether or not the “trajectory generation status” of the operation generation section 22 is “in operation” or as to whether or not the “trajectory generation status” of the operation generation section 22 requires an “operation command” is NO, “emission location: no location on a main body” is set (step S312).

Next, “arm trajectory generation status” which is operation of the arm control section 23 is checked in connection with the arms 4 (step S313).

Subsequently to step S313, a determination is made as to whether or not the arms 4 are “in operation or require an operation command” (step S314).

When a result of determination made as to whether or not the arm is in operation or requires an operation command is YES, a determination is sequentially made, in connection with individual operations, as to whether the forearm is in operation or requires a command and as to whether or not the upper arm is in operation or requires a command. When the result of determination is YES, a corresponding “emission location” is set on the nozzles 8 of the respective arms 4 in accordance with the thus-determined motion, (steps S316 to S318).

When all results of the determinations made as to whether the forearm is in operation or requires a command and as to whether or not the upper arm is in operation or requires a command are NO, “emission location setting for another operation (hand operation or the like): set no emission location on an arm” is set (step S319).

When a result of determination made, in step S314, as to whether or not the arms are in operation or there is an operation command is NO, “emission location setting: no location on an arm” is set (step S320).

After “emission location setting: set no location on an arm” or an “emission location” has been set in step S320 (step S316, S318, or step S319), processing is completed.

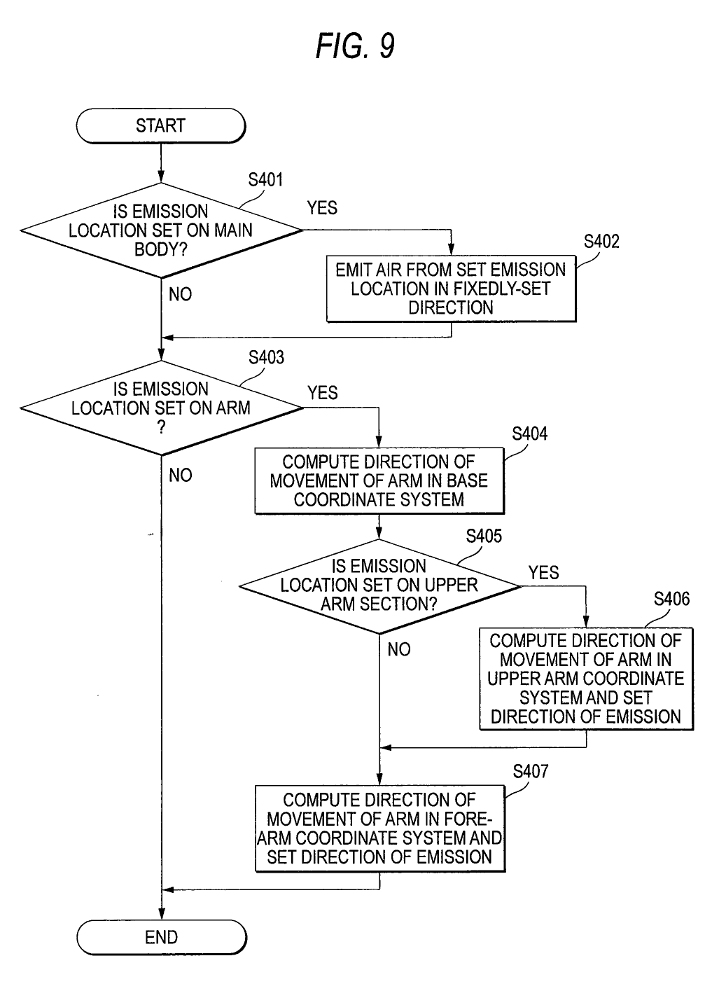

Detailed internal steps of “setting the direction of air emission” (step S4) of the basic steps shown in FIG. 5 will now be described. FIG. 9 is a flowchart of detailed internal steps of “setting the direction of air emission (step S4).”

In connection with a setting “whether or not an emission location is set on the main body,” a determination is made as to whether or not an emission location is set on the main body (step S401).

When a result of the determination made as to “whether or not an emission area is set on the main body” is YES, “emit air from the emission location toward a fixedly-set direction” is set (step S402).

A determination is now made as to whether or not an air emission location is set on the arm (step S403).

In the meantime, even when a result of determination made as to whether or not an emission location is set on the main body is NO, a determination is made as to whether or not an emission location is set on the arm (step S403).

When the result of the determination made, in step S403, as to whether or not the emission location is set on the arm is YES, a direction of movement of the arm in a base coordinate system is computed in connection with the base coordinate system shown in FIG. 6 (step S404).

Next, a determination is made as to whether or not an air emission location is set on the upper arm, in connection with an upper arm 4b of the arm 4 (step S405).

When the result of the determination made as to whether or not an air emission location is set on the upper arm is YES, “compute the direction of operation of an arm within a forearm coordinate system and the direction of air emission” is set (step S406).

Next, the “computation of the direction of operation of an arm within a forearm coordinate system and the direction of air emission” is set (step S407).

In the meantime, when the result of the determination made as to whether or not an air emission location is set on the upper arm is NO, “compute the direction of operation of the arm 4 within a forearm coordinate system and the direction of air emission” is set (step S407).

After setting pertaining to step S407 has been made or when the result of the determination made in step S403 as to whether or not an air emission location is set on the arm is NO, processing is completed.

Internal detailed steps of “setting the amount and speed of air emission” (step S5) of the basic step shown in FIG. 5 will now be descried. Detailed internal steps of “setting the amount and speed of air emission” (step S5) include four modes, and the respective modes will be sequentially described hereunder.

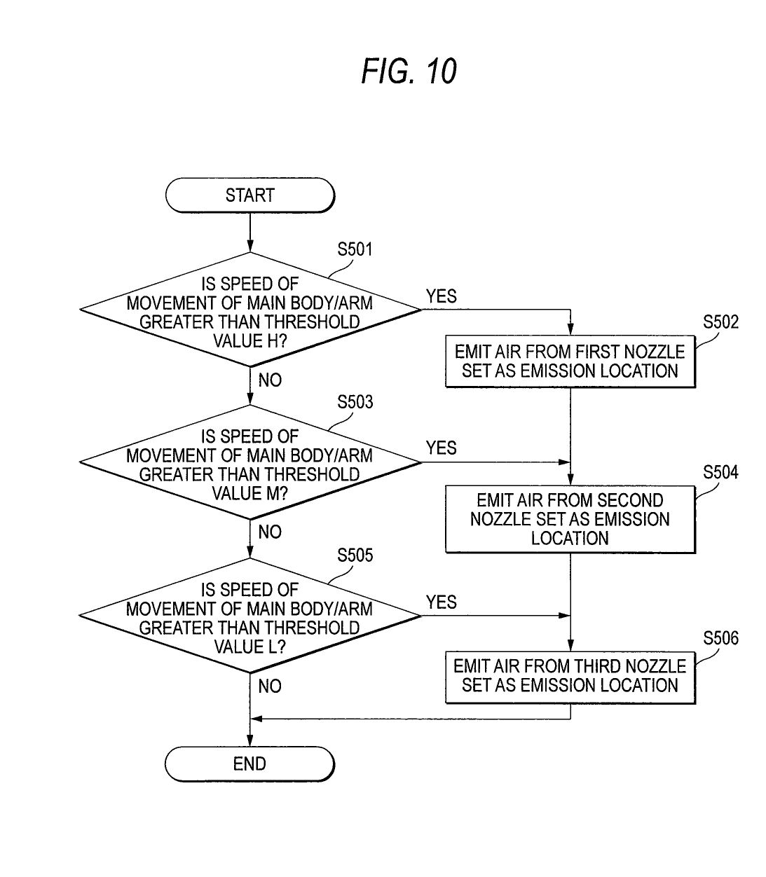

FIG. 10 is a flowchart showing detailed steps of an internal first mode of the “setting the amount and speed of air emission” (step S5).

In the first mode, settings are made in such a way that an air is emitted from the nozzles 8 which are in number proportional to the travel speed of the robot main body 2a of the robot structural body 2 and the travel speed of the arms 4 of the same. Specifically, the travel speed are compared with a plurality of threshold values, thereby setting the number of emission nozzles 8, among the plurality of nozzles 8 provided on the robot structural body and the arms 4, in accordance with a result of comparison.

First, the travel speed of the main body and the travel speed of the arms 4 are compared with a first threshold value H. Specifically, a determination is made as to whether or not the travel speed of the main body/the arm greater than the threshold value H (step S501).

When a result of the determination made as to whether or not the travel speed of the main body/the arm is greater than the threshold value H is YES, “an air is emitted from the 81^{st} nozzle set as the emission location,” “an air is emitted from the 82^{nd} nozzle set as the emission location,” and “an air is emitted from the 83^{rd} nozzle set as the emission location” are set (steps S502, S504, and S506).

When the result of the determination made, in step S501, as to whether or not the travel speed of the main body/the arm is greater than the threshold value H is NO, the travel speed of the main body and the travel speed of the arm 4 are compared with the second threshold value M. Specifically, a determination is made as to whether or not the travel speed of the main body/the arm is greater than the threshold value M (step S503).

When the result of the determination made, in step S503, as to whether or not the travel speed of the main body/the arm is greater than the threshold value M is YES, “an air is emitted from the 82^{nd} nozzle set as the emission location” and “an air is emitted from the 83^{rd} nozzle set as the emission location” are set (steps S504 and S506).

When the result of the determination made, in step S503, as to whether or not the travel speed of the main body/the arm is greater than the threshold value M is NO, the travel speed of the main body and the travel speed of the arm 4 are compared with a third threshold value L. Specifically, a determination is made as to whether or not the travel speed of the main body/the arm is greater than the threshold value L (step S505).

When the result of the determination made, in step S505, as to whether or not the travel speed of the main body/the arm is greater than the threshold value L is YES, “an air is emitted from the 83^{rd} nozzle set as the emission location” is set (step S506).

When the result of the determination made, in step S505, as to whether or not the travel speed of the main body/the arm is greater than the threshold value L is NO or after “an air is emitted from the n^{th} nozzle set as an emission location” is set (steps S502, S504, and S506), processing is completed.

A second mode of the internal detailed steps of “setting the amount and speed of air emission” (step S5) of the basic step shown in FIG. 5 will now be descried.

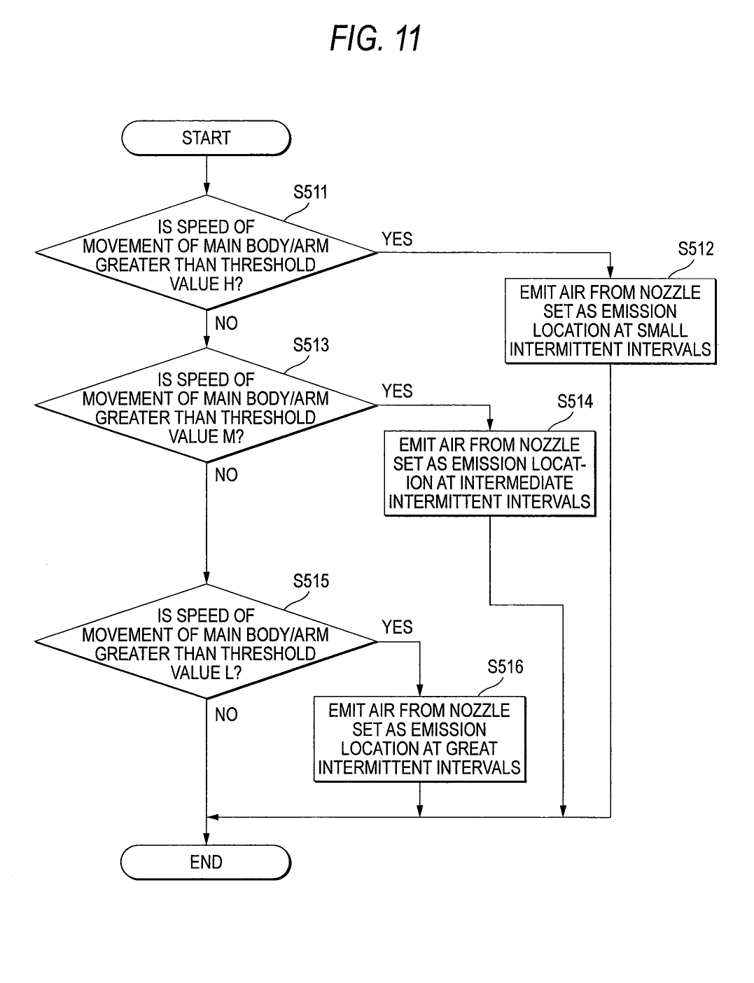

FIG. 11 is a flowchart showing detailed steps of the internal second mode of the “setting the amount and speed of air emission” (step S5).

In the second mode, an air is emitted from the nozzles 8 at a frequency proportional to the travel speed of the robot structural body 2 and the travel speed of the arms 4. Specifically, the travel speed of the robot main body 2 and the travel speed of the arms 4 are compared with a plurality of threshold values, and the frequency of air emission from the emission nozzles 8 is set in accordance with a result of comparison.

First, the first threshold value H is compared with the travel speed of the robot structural body 2 and the travel speed of the arms 4. Specifically, a determination is made as to whether or not the travel speed of the main body/the arm greater than the threshold value H (step S511).

When a result of the determination made as to whether or not the travel speed of the main body/the arm is greater than the threshold value H is YES, “an air is emitted from the nozzle 8 set as an emission location at small intermittent intervals” is set (step S512).

When the result of the determination made, in step S511, as to whether or not the travel speed of the main body/the arm is greater than the threshold value H is NO, the travel speed of the robot structural body 2 and the travel speed of the arm 4 are compared with the second threshold value M. Specifically, a determination is made as to whether or not the travel speed of the main body/the arm is greater than the threshold value M (step S513).

When the result of the determination made, in step S513, as to whether or not the travel speed of the main body/the arm is greater than the threshold value M is YES, “an air is emitted from the nozzle 8 set as an emission location at intermediate intermittent intervals” is set (step S514).

When the result of the determination made, in step S513, as to whether or not the travel speed of the main body/the arm is greater than the threshold value M is NO, the travel speed of the robot structural body 2 and the travel speed of the arm 4 are compared with the third threshold value L. Specifically, a determination is made as to whether or not the travel speed of the main body/the arm is greater than the threshold value L (step S515).

When the result of the determination made, in step S515, as to whether or not the travel speed of the main body/the arm is greater than the threshold value M is YES, “an air is emitted from the nozzle 8 set as an emission location at great intermittent intervals” is set (step S516).

When the result of the determination made, in step S515, as to whether or not the travel speed of the main body/the arm is greater than the threshold value L is NO or “an air is emitted from a nozzle set as an emission location at an intermittent interval “n” has been set (steps S512, S514, and S516), processing is terminated.

A third mode of the internal detailed steps of “setting the amount and speed of air emission” (step S5) of the basic step shown in FIG. 5 will now be descried.

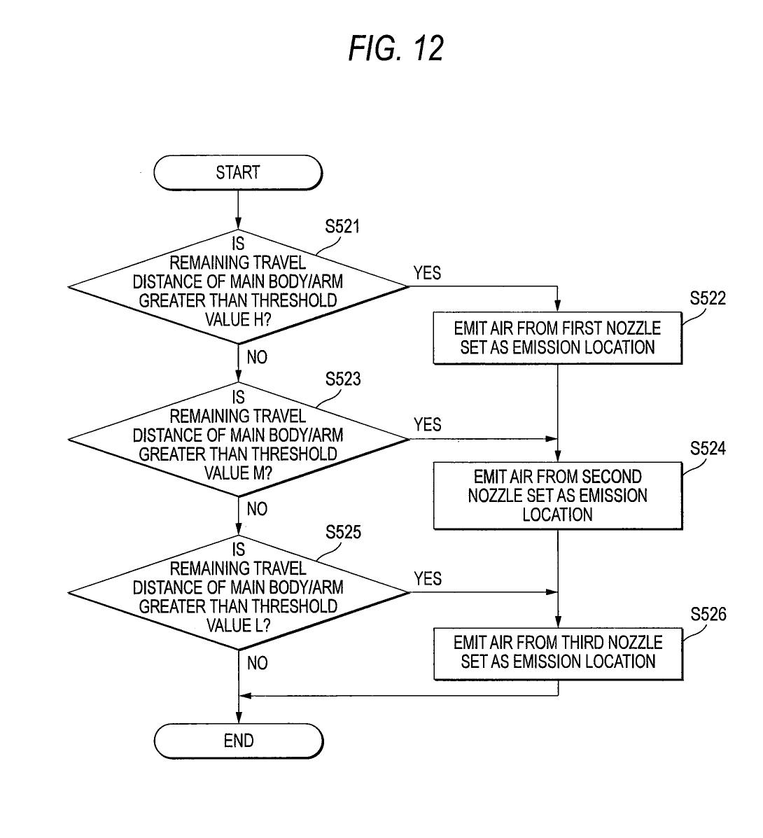

FIG. 12 is a flowchart showing detailed steps of the internal third mode of the “setting the amount and speed of air emission” (step S5).

In the third mode, an air is emitted from the nozzles 8 which are equal in number to the remaining distance of the robot structural body 2 and the remaining distance the arms 4. Specifically, a remaining distance of the robot main body 2 and a remaining distance of the arms 4 are compared with a plurality of threshold values, and the number of emission nozzles 8 is set in accordance with a result of comparison.

First, the remaining distance of the robot structural body 2 and the remaining distance of the arms 4 are compared with a first threshold value H. Specifically, a determination is made as to whether or not the remaining distance of the main body/the arm greater than the threshold value H (step S521).

When a result of the determination made as to whether or not the remaining distance of the main body/the arm is greater than the threshold value H is YES, “an air is emitted from the 1^{st} nozzle set as the emission location,” “an air is emitted from the 2^{nd} nozzle set as the emission location,” and “an air is emitted from the 3^{rd} nozzle set as the emission location” are set (steps S522, S524, and S526).

When the result of the determination made, in step S521, as to whether or not the remaining distance of the main body/the arm is greater than the threshold value H is NO, the remaining distance of the main body and the remaining distance of the arm 4 are compared with the second threshold value M. Specifically, a determination is made as to whether or not the remaining distance of the main body/the arm is greater than the threshold value M (step S523).

When the result of the determination made, in step S521, as to whether or not the remaining distance of the main body/the arm is greater than the threshold value M is YES, “an air is emitted from the 2^{nd} nozzle set as the emission location” and “an air is emitted from the 3^{rd} nozzle set as the emission location” are set (steps S524 and S526).

When the result of the determination made, in step S523, as to whether or not the remaining distance of the main body/the arm is greater than the threshold value M is NO, the remaining distance of the main body and the remaining distance travels of the arm 4 are compared with a third threshold value L. Specifically, a determination is made as to whether or not the remaining distance of the main body/the arm is greater than the threshold value L (step S525).

When the result of the determination made, in step S525, as to whether or not the distance traveled by the main body/the arm is greater than the threshold value L is YES, “an air is emitted from the 3^{rd} nozzle set as the emission location” is set (step S526).

When the result of the determination made, in step S525, as to whether or not the distance traveled by the main body/the arm is greater than the threshold value L is NO or after “an air is emitted from the n^{th} nozzle set as an emission location” is set (steps S522, S524, and S526), processing is completed.

A fourth mode of the internal detailed steps of “setting the amount and speed of air emission” (step S5) of the basic step shown in FIG. 5 will now be descried.

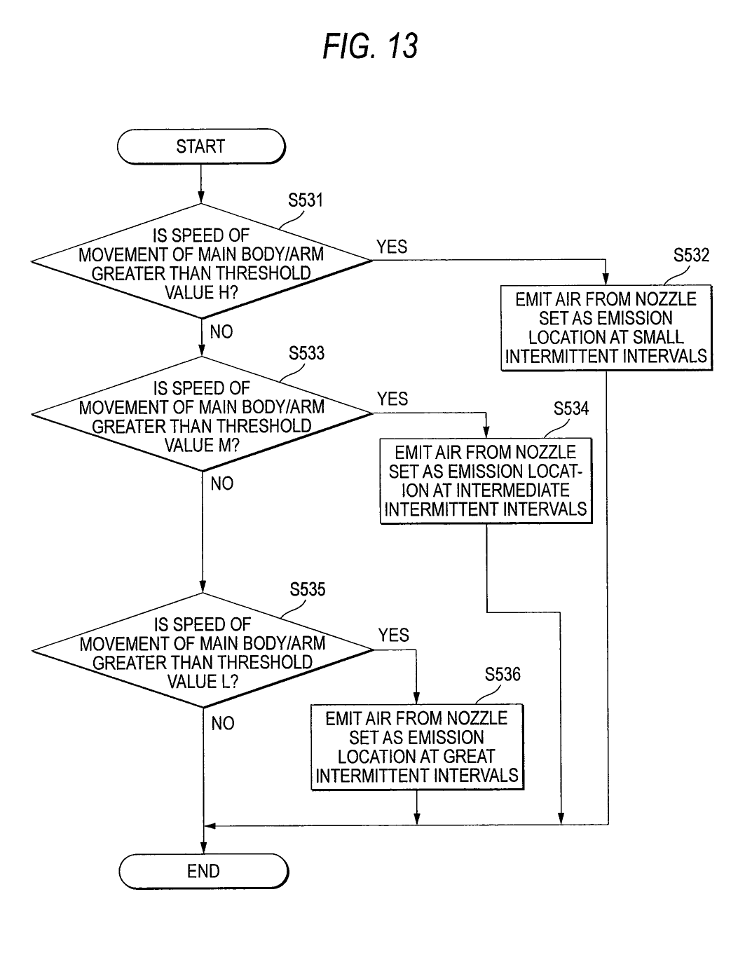

FIG. 13 is a flowchart showing detailed steps of the internal fourth mode of the “setting the amount and speed of air emission” (step S5).

In the fourth mode, an air is emitted from the nozzles 8 at a frequency proportional to the remaining speed of the robot structural body 2 and the remaining speed of the arms 4. Specifically, the travel speed of the robot main body 2 and the travel speed of the arms 4 are compared with a plurality of threshold values, and the frequency of air emission from the emission nozzles 8 is set in accordance with a result of comparison.

First, the first threshold value H is compared with the travel speed of the robot structural body 2 and the travel speed of the arms 4. Specifically, a determination is made as to whether or not the travel speed of the main body/the arm greater than the threshold value H (step S531).

When a result of the determination made as to whether or not the travel speed of the main body/the arm is greater than the threshold value H is YES, “an air is emitted from the nozzle set as an emission location at small intermittent intervals” is set (step S532).

When the result of the determination made, in step S531, as to whether or not the travel speed of the main body/the arm is greater than the threshold value H is NO, the travel speed of the robot structural body 2 and the travel speed of the arm 4 are compared with the second threshold value M. Specifically, a determination is made as to whether or not the travel speed of the main body/the arm is greater than the threshold value M (step S533).

When the result of the determination made, in step S533, as to whether or not the travel speed of the main body/the arm is greater than the threshold value M is YES, “an air is emitted from the nozzle set as an emission location at intermediate intermittent intervals” is set (step S534).

When the result of the determination made, in step S533, as to whether or not the travel speed of the main body/the arm is greater than the threshold value M is NO, the travel speed of the robot structural body 2 and the travel speed of the arm 4 are compared with the third threshold value L. Specifically, a determination is made as to whether or not the travel speed of the main body/the arm is greater than the threshold value L (step S535).

When the result of the determination made, in step S535, as to whether or not the travel speed of the main body/the arm is greater than the threshold value M is YES, “an air is emitted from the nozzle 8 set as an emission location at great intermittent intervals” is set (step S536).

When the result of the determination made, in step S535, as to whether or not the travel speed of the main body/the arm is greater than the threshold value L is NO or “an air is emitted from a nozzle set as an emission location at an intermittent interval “n” has been set (steps S532, S534, and S536), processing is terminated.

Typical example operation modes of the robot having the foregoing structure will now be illustrated. In the following descriptions of the operation modes, the individual sections are described by reference to FIGS. 1 through 4, and operations are described by reference to FIGS. 5 through 13, and hence their explanations are omitted.

(First Operation Mode)

As shown in FIG. 2, the robot is a robot coexistent with a human having: the air emission ports 6 provided in the surface of the robot main body 2a and the surfaces of the arms 4 of the robot structural body 2; and the function of emitting an air from the air emission nozzles 8 provided in the surface of the robot main body 2a immediately before or during operation of the robot main body 2a of the robot structural body 2, thereby showing the presence, timing of movement, and a range of movement to persons located around the robot.

Upon initiation of movement, the robot 1 starts emitting an air. After completion of movement, the robot also finishes emitting an air. As a result, the persons located around the robot 1 can be made aware of whether or not the robot 1 is in operation.

Further, as a result of the air being emitted from the air emission nozzles 8 provided in the surface of the robot main body 2a several seconds before initiation of movement of the robot 1, initiation of operation of the robot 1 can be shown to those located around the robot. Moreover, when the robot 1 makes right-turn movement, a larger amount of air is emitted in a right forward direction.

Moreover, when the speed of emission of the air in the direction of movement (direction of travel) of the robot 1 or the travel speed of the robot 1 is increased, the intensity or amount of air emissions can also be changed proportionally. As a result, the movement of the robot 1 can be shown in detail to the persons located around the robot.

Moreover, the intensity or amount of the air emitted from the surface of the robot main body 2a is changed in proportion to a remaining distance to an operation target location of the traveling robot 1, so that a distance to the operation target position and an arrival time can also be shown to those located around the robot.

Thereby, it is possible to draw attention of persons located in a direction where the robot 1 might come into collision with the persons as a result of movement, to thus urge the persons to evacuate.

The air emitted from the air emission nozzles 8 is discharged continuously or intermittently, whereby the amount of air emissions is reduced, and an operation time of the incorporated compressed-air cylinder 11 can be made longer.

(Second Operation Mode)

As in the case of the robot described in connection with the first operation mode, the robot 1 has the air emission nozzles 8 provided in the surface of the robot main body 2a. An air is emitted from the air emission nozzles 8 provided in the surface of the robot main body 2a immediately before or during operation of the arms 4 attached to the robot main body 2a. The robot has the function of showing the presence, timing of movement, and a range of movement of the robot 1 to persons located around the robot by the air.

As described in connection with the first operation mode, the robot 1 emits an air out of the air emission nozzles 8 provided in the surface of the robot main body 2a in synchronism with movement of the arms 4, as in the case of movement of the robot main body 2a. By the air, details about the movements of the arms 4 are shown to those located around the robot, thereby drawing attention of persons located in a direction where the robot 1 might come into collision with the persons as a result of movement, to thus urge the persons to evacuate.

(Third Operation Mode)

The robot 1 has the air emission nozzles 8 provided in the surface of the arms 4 attached to the robot, and an air is emitted from the air emission nozzles 8 provided in the surface of the arms 4 immediately before or during operation of the robot main body 2a or the arms 4. The robot has the function of showing the presence, timing of movement, and a range of movement of the robot 1 to persons located around the robot by the air.

The air emission nozzles 8 provided in the surface of each arm 4 are provided in four directions; namely, the upper direction, the lower direction, the right direction, and the left direction, at each end of one link of the arm 4 as shown in FIG. 3. Consequently, an air is emitted from the air emission nozzle 8 of the arm 4 in a direction where the arm 4 is to move, thereby drawing attention of persons located in the direction where the robot might come into collision with the persons, to thus urge the persons to evacuate.

As in the case of operation for emitting an air from the surface of the robot main body 2a described in connection with the second operation mode, an air is emitted from the air emission nozzles 8 provided in the surface of the arms 4 in synchronism with movement of the arms 4. By the air, details about the movements of the arms 4 can be shown to those located around the robot. Further, as a result of the emission nozzles 8 being provided in the surfaces of the arms 4, submission of information, withdrawal of attention, and urging of evacuation conforming movement of the arms 4 can be performed.

In the case of the operation mode, the extremities (the grip sections 7) of the arms 4 jutting out of the robot main body 2a of the robot structural body 2 are particularly effective for preventing collision when the extremities may come into collision with a person located around the robot in association with movement of the robot main body 2a of the robot structural body 2.

Modifications to the previously-described robot will now be described.

The robot 1 described in connection with the previously-described first through third operation modes informs the persons located around the robot of the presence, timing of motion, and a range of movement of the robot 1 by the air emitted from the air emission nozzles 8 provided in the surface of the robot main body 2a and the surfaces of the arms 4.

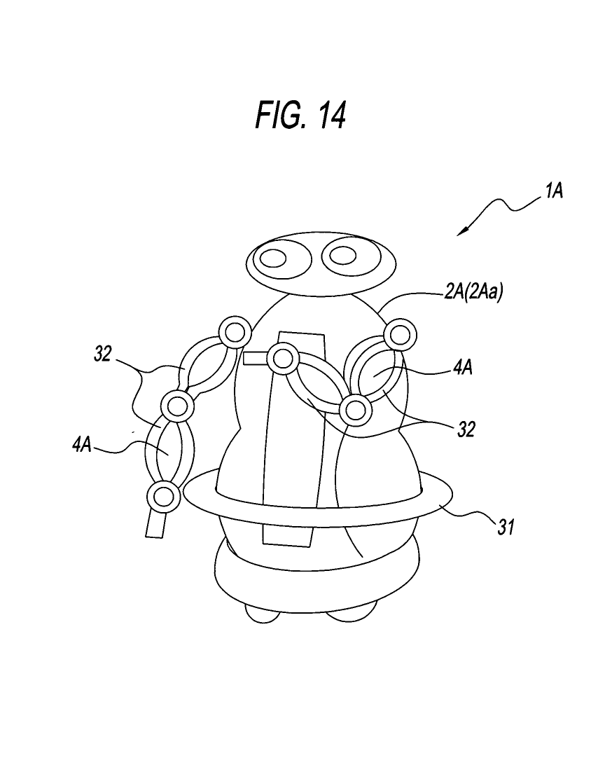

As an external view of the robot is shown in FIG. 14, the basic structure of a robot 1A of the modification is identical with the configuration of the robot shown in FIG. 1. However, elastic, pneumatic shock-absorbing bumpers 31 and 32 are provided around a robot main body 2a and arms 4A of a robot structural body 2A. At the time of movement of the robot 1A or operation of the arm 4A, an air is forced into the pneumatic shock-absorbing bumpers 31 and 32 from the compressed-air cylinder 11, thereby inflating the pneumatic shock absorbing bumpers 31 and 32.

As a result of the air being forced into the pneumatic shock-absorbing bumpers 31 and 32, to thus inflate the bumpers, the robot can have the function of visually showing initiation of operation to persons located around the robot and alleviating physical impact, which would otherwise be caused by collision.

In this case, an air is not emitted directly to the outside, persons located around the robot 1A cannot be caused to feel the presence of the robot by the flow of an air. However, under a noiseless environment, the persons can be caused to realize the robot by the sound caused by forcing an air into the pneumatic shock-absorbing bumpers 31 and 32.

Since the robot 1A does not discharge an air to the outside of the robot 1A, the life of the compressed-air cylinder 11 can be made longer. When operation of the robot main body 2A and operation of the arm 4 of the robot structural body 2A is completed, supply of an air to the pneumatic shock-absorbing bumpers 31 and 32 from the compress-air cylinder 11 is stopped. At that time, since the pneumatic shock-absorbing bumpers 31 and 32 are formed from an elastic member, the bumpers become shrunk because of elastic restoration force of the elastic element.

As described above, air pressure is utilized as human-safe measures in connection with any of the human-safe robots. The presence, timing of movement, and operation range of the robot can be shown to persons around the robot who do not watch the robot carefully, thereby turning their attentions toward the possibility of occurrence of collision of the robot main body or the arm of the robot with the persons. Thus, occurrence of a trouble, such as infliction of an injury on a person which would otherwise be caused as a result of collision of the robot with a person, can be avoided.

According to the above-mentioned embodiment, the robot can show the presence, timing of motion, and a range of movement of a robot to a person; draw attention of a person who is entering a range of movement of the robot; and urge the person to evacuate in order to avoid collision.

The present invention is not limited directly to the embodiments but can be embodied in a practical phase by modification of the constituent elements within the scope of the invention. Further, various inventions can be created by appropriate combinations of the plurality of constituent elements described in connection with the embodiments. For example, some may also be deleted from tall of the constituent elements described in the embodiments. Moreover, constituent elements of different embodiments may also be combined as necessary.

What is claimed is:

1. A robot comprising:
a body;
a arm attached to the body;
a container storing compressed air;
at least one air emission port formed in at least one of a surface of the body and a surface of the arm;
a pipe network connecting the container to the air emission port; and
a control section configured to control the body, the arm, and emission of an air based on an operation of at least one of the body and the arm.

2. The robot according to claim 1, wherein the control section sets a direction where the compressed air is emitted form at least one of the air emission ports immediately before either one of the body and the arm is operated and controls the compressed air emitted from the at least one air emission port in a direction in which either one of the body and the arm is moved.

3. The robot according to claim 1, the control section sets a direction where the compressed air is emitted and a portion of the robot where the compressed air is emitted while either one of the body and the arm is operated and controls the compressed air emitted from the at least one air emission port in a direction where either one of the body and the arm is moved.

4. The robot according to claim 1, wherein the control section sets a direction where the compressed air is emitted and a portion of the robot where the compressed air is emitted immediately before either one of the body and the arm is operated and controls the compressed air emitted from the at least one air emission port toward a range where either one of the body and the arm is moved.

5. The robot according to claim 1, wherein the control section sets a direction where the compressed air is emitted and a portion of the robot where the compressed air is emitted while either one of the body and the arm is operated and controls the compressed air emitted from the at least one air emission port toward a range where either one of the body and the arm is moved.

6. The robot according to claim 1, wherein the control section calculates where either one of the body and the arm is positioned after a predetermined period of time is passed, and
wherein the control section sets a direction where the compressed air is emitted and a portion where the compressed air is emitted and controls an air emitted from the at least one air emission port toward the calculated position of either one of the body and the arm.

7. The robot according to claim 2, wherein, when the control section sets the portion of the robot where the compressed air is emitted, the control section controls the compressed air emitted from the at least one air emission port conforming to an operation of the body in a predetermined direction if the body is moved, and
wherein, when the control section sets the portion of the robot where the compressed air is emitted, the control section controls the compressed air emitted from the at least one air emission port conforming to an operation of the arm in a different direction if the arm is moved.

8. The robot according to claim 2, wherein, when the control section sets the direction where the compressed air is emitted, the control section controls the compressed air emitted from the at least one air emission port formed in the surface of the body, in a predetermined direction, and
wherein, when the control section sets the direction where the compressed air is emitted, the control section calculates, based on an operation of the arm, a first direction conforming to a direction in which the arm is moved and controls the compressed air emitted from the at least one air emission port formed in the surface of the arm in the first direction.

9. The robot according to claim 2, wherein, when either one of the body and the arm is operated, the control section emits the compressed air from the at least one air emission port in the surface of either one of the body and the arm at air emission speed or in an amount of air emission proportional to speed of movement of either one of the body and the arm.

10. The robot according to claim 2, wherein, when either one of the body and the arms is operated, the control section emits the compressed air from at least one air emission port in either one of the surface of body and the surface of arm at air emission speed or in an amount of air emission proportional to a remaining distance to an operation target position of either one of the body and the arm.

11. The robot according to claim 9, wherein the compressed air is controlled by the control section so as to be intermittently emitted, at a frequency proportional to the speed of movement or the remaining travel distance, from the at least one air emission port in either one of the surface of body and the surface of arm.

12. The robot according to claim 10, wherein the compressed air is controlled by the control section so as to be intermittently emitted, at a frequency proportional to the speed of movement or the remaining travel distance, from the at least one air emission port in either one of the surface of body and the surface of arm.

13. The robot according to claim 1, wherein the compressed air is supplied from the container to the at least one air emission port through an electromagnetic valve.

14. The robot according to claim 1, wherein the at least one air emission port is formed in at least a front face of the body, a back face of the body, a right face of the body, and a left face of the body and an upper arm face of the arm and a forearm face of the arm.

15. The robot according to claim 11, wherein the control section comprises:
an operation trajectory generation section configured to calculate an operation trajectory of the robot;
a calculating section configured to calculate the portion of the robot where the compressed air is emitted, a direction where the compressed air is emitted, and timing when the compressed air is emitted; and
an electromagnetic control section configured to control the electromagnetic valve.

16. A robot comprising:
a body;
a arm attached to the body;
a container storing compressed air;
at least one air emission port formed in at least one of a surface of body and a surface of arm;
a pipe network connecting the container to the at least one air emission port;
a bumper formed on at least one of the surface of body and the surface of arm and inflatable by accumulating the compressed air emitted from the at least one air emission; and
a control section configured to control the body, the arm, and emission of air, and capable of inflating the bumper when the robot starts operation.
